(19) United States
(12) Patent Application Publication
(10) Pub. No.: US 2003/0229810 A1
(43) Pub. Date: Dec. 11, 2003

(54) Optical antivirus firewall for internet, LAN, and WAN computer applications

(76) Inventor: Joseph J. Bango, New Haven, CT (US)

Correspondence Address: Att: Joseph J. Bango, Jr., CONN. ANALYTICAL CORP., 696 AMITY ROAD, BETHANY, CT, 06524, US

(21) Appl. No.: 10/455,826

(22) Filed: Jun. 5, 2003

Related U.S. Application Data
(60) Provisional application No. 60/386,273, filed on Jun. 5, 2002.

(51) Int. Cl. G06F 11/30

(52) U.S. Cl. 713/201

(57) ABSTRACT

This invention discloses a means of preventing software virus attacks on personal computers and computing devices, data networks, and internet host computer systems. By converting incoming data to an image file and displaying the same, coupled to a specialized area array image detector, the resulting information is reconverted into appropriate formatted document style and embedded images, if any. The invention provides internet isolation and PC file protection, obviating hacker interrogation.

### BACKGROUND

1. Field of Invention

This invention relates in general to computer security, and in particular to a means of preventing software virus attacks on internet host computer systems, in addition to isolating potential virus penetration of individual personal computers, or servers connected to local and wide area networks. The invention also provides internet isolation and PC file protection.

2. Background Description of Prior Art

Ever since the introduction of the personal computer and the subsequent exponential growth of the internet, there has been an equally significant, albeit disconcerting, growth in the number of computer viruses being generated and distributed. Coupled with these viruses are attempts by unauthorized individuals to penetrate internet, LAN, and WAN computer hosts, colloquially known as “hacker attacks”. As a result, anti-virus software firms have been created to combat the problem, such as McAfee Associates of New York. Many of these firms maintain a database of all known and emerging viruses, and develop appropriate software tools to nullify and eradicate a suspect virus from a given target computer. In addition, some software applications, such as Symantic's Norton Anti Virus, can be configured to scan all incoming data and flag any attempts to modify the computer's boot sector or other vital operating system function which are often tell tale signs of a potentially damaging virus attack. These approaches either require some prior knowledge of the virus, or can impede normal full computer function and/or data exchange. In addition, the increased virus distribution via email has resulted in computer users to take pause in opening any email, antivirus software notwithstanding.

Because viruses are composed of software instruction sets, various means have been developed that seek to isolate what appear to be aberrant computer commands Computer data is transferred in packets called strings, which consist of binary information in octal or hexadecimal groups. Each group may represent either character sets or control functions. A virus may exist as a command appended to normal data flow, or it may exist as a complete program designed to execute a function or series of functions designed to corrupt data, or deny user access. Prior art examination will provide some insight into what approaches have been undertaken to identify and isolate aberrant viral code before computer damage may occur.

From an exhaustive search of the patent literature, there appears to be no such prior art that is the same or similar to the present proposed invention. There are however, a number of patents that claim to filter a virus using an opto-coupler. The concept an application of these patents, however, is entirely different than the concept and application of the present disclosed invention. Consider U.S. Pat. Nos. 06,081,894, 06,003,132, 05,663,819, 00,036,516, 09,929,066, and 09,921,317. In every cited instance, an opto-coupler is used to isolate sender and receiver binary data flow. The data stream is serial in operation. The disclosed invention reveals a means of employing data display that is optically converted by a plurality of optocouplers. The prior art differs from the present invention in that the opto-coupler is controlled by a switch and can be used to cut off an inflow or outflow of data. The control is determined by an electronic device which senses a virus (using a predetermined protocol) and then tells the opto-coupler to turn off the transceived data if a virus is detected. Suppose, that a new virus is created at some point in the future. This new virus does not fit the predetermined protocol, and hence the electronic control does not shut off the opto-coupler, and thus the virus gets through. In fact, no software based firewall will prevent every virus from getting through. If a signal plus virus is input the proposed device and also input to an opto-coupler without an electronic control, the results would be different: (i) the proposed device converts the virus into usable or non-usable visual data, in which case the virus instruction might manifest itself as aberrant electronic signal representing the visual picture of the virus, or, (ii) the opto-coupler with no external control (or even with an external control that does not recognize the virus) will pass binary or analog data between the isolated electric stages, and it will pass both signal and virus equally well.

U.S. Pat. No. 05,991,335 which discloses another use of an opto-coupler. The external control proposed in the previous patents is in extent here, but in a more subtle manner. Digital or analog data is pulse-modulated (pulse position modulated). It is transmitted through the opto-coupler, and then the electric signal is integrated to eliminate the data signal of the virus. The degree of success of this approach is severely compromised if the virus is one which has yet to characterized. Hence, this patent (like the others previously discussed) is different from the present proposed patent for the reasons discussed above.

U.S. Pat. No. 09,845,778, like the other patents discussed thus far, uses an external controller to interrupt data flow if a virus is detected. Detection of a virus depends on a predetermined set of protocols, and hence this patent can not guard against virus that have yet to be developed.

### DETAILED DESCRIPTION OF THE INVENTION

The disclosed invention functions by converting the intended computer message derived from an application program, web page, or image file, into a suitable graphical image file unrelated to the original data stream instruction set. For example, if information containing malicious viral code were transmitted from a host computer to a guest computer but was intercepted by a suitable processor “staging area” which only functions to convert data into a graphical form, said processor being configured so as not to respond to any commands which affect operating system functions. If the said processor had as its only function to display incoming data as intended, possibly using a liquid crystal or Thin Film Transistor display, and this data was duplicated via an suitable optical detector or gate array such as a CCD (Charge Coupled Device), the resulting image captured by the detector would bear no resemblance to the original code which created the parent displayed image nor any malicious code attached therein. In the crudest sense, information displayed on an infected computer's screen photographed by a digital or other camera, where such image is digitally submitted to a second computer obviates any means for viral code to be transferred. In the preferred embodiment, the optical converter in the staging area will be a hybrid integrated VLSI chip where an optical emitter will be paired with an optical detector at the substrate level, permitting a high degree of conversion accuracy and speed, resulting in little or no image degradation during the conversion process. Such a VLSI circuit could be fashioned along the lines of commercially available LCD or TFT image displays and CCD image detectors, with horizontal and vertical emitter and detection cells the quantity of which determines the desired device resolution. In the remote possibility that aberrant malicious viral computer code could affect the display processing portion of the staging area, in no event would such code be capable of traversing the optical threshold inherent in the staging area.

The disclosed invention optical firewall is unique in that it can filter out viruses that have yet to be created. For example, suppose a signal plus virus is input to the disclosed firewall. In the first stage a “scpu” (called an scpu or staging-cpu) takes the data and converts it to graphical form. The scpu is wired or programmed for only this application. It will not absorb any of the command control information from either the signal or the virus, unless such operation is intentionally desired in a proxy operational mode. Once the input signal/virus is displayed graphically, it is coupled to a sensor “camera”. The camera can be a TFT, CCD unit or any other device that essentially photographs the images created by the input. The input signal is thus converted to a visual picture which is then photographed and reconverted to binary data. This binary data is then sent on the system cpu and processed in the normal manner. The input virus is converted to a visual picture and this picture is reconverted to binary data, which is sent to the cpu. The key here is that the virus does not enter the cpu. Only the data that constitutes a picture of the virus enters the cpu. The cpu can then process the data as a picture, or it can ignore the data, or it can signal the human user that there is something in the incoming data stream that it can not configure. In all cases, the virus is stopped before initiating any subsequent damage.

An opto-coupler works on the principle that electricity is converted to light, which is then reconverted back to electricity. Opto-couplers consist of a single light source (laser or LED) and a sensor (pin-diode, photo-transistor, photo-resistor, etc.). Although light is used to isolate two “electric” stages, the light only transmits serial data in a digital or analog format. The present proposed invention transmits composite graphical data between two electric stages. In an opto-coupler the color of the light is monochromatic: once the color is set for maximum coupling, there is no need for any change in color. With the proposed invention, a picture is transmitted. Hence, the grayscale, colors and hues and other visual information must be transmitted. In an opto-coupler, the light intensity is only important to effect proper levels of modulation and demodulation; the light intensity itself is not important. In the proposed device, the light intensity varies over the different geographical points of the picture, and is thus important for a faithful visual reproduction of the picture.

If adapted to provide secure internet access between a host server and multiple guest computers wishing to navigate the host site, the disclosed invention can be altered slightly to yield a virtually impenetrable firewall yet provide reasonable guest access to the site. For example, most web sites are comprised of geographical zones where virtual “tabs” or “control buttons” are located that when activated, performing some predetermined function for the guest. Such functions might include file downloads or access to another web page. In order to “toggle” these functions, the user must move the mouse cursor to the prescribed geographical location where the desired virtual function is located on the computer display and “click” the appropriate mouse button to communicate to the host a desire to activate that function. As a consequence, cursor geographical x-y coordinate data and mouse button command binary data must be transmitted to the host. Such data transmission offers a vulnerability where undesirable viral data can be “tagged” along with the uplink command. An alternative approach offered by the disclosed invention permits the geographical location of a mouse or similar pointing device to be represented on a display device optical coupler where such a coupler includes a suitable optical detection device such as a CCD, where the x-y geographical location of the pointing device is directly transferred to the host devoid of any hardwire ASCII or other binary commands. In a similar fashion, specific optical geographical locations or regions in the display image converter can be assigned to permit control functions such as function key operations to be effected across the staging area.

Another embodiment of the graphical staging area interface would permit a host system to receive text or numerical data devoid of ASCII or other binary code. Such may be used to receive credit card numbers but preclude hacker attempts to download the same. In this embodiment, a glyph indicative of a symbol, or alphanumeric character, is displayed in the staging area and transferred as an image through the optical detector as described previously. However, interpretation of the symbol or glyph is performed via OCR or Optical Character Recognition software.

Such software compares the image file, possibly a bitmap, to known glyphs in the software database and generates the associated ASCII or other binary code representative of that glyph to be then forwarded to the designated computer. No viral code can transverse this process, however the process itself will delay data transfer by a finite time. For purposes of secure financial or personal data transfer, the minor processing delay is inconsequential.

In yet another embodiment of the disclosed invention, an effective, albeit less secure, firewall can be effected via software alone. In this approach, the “staging area” is created through software and no external hardware required. Most operating system platforms such as Microsoft Windows® and Apple Macintosh® provide a functions whereby screen “snapshots” may be effected, resulting in image “PICT” format files. Because the original program and all the associated linked data required to effect the image on the computer display are not represented in the ensuing screen snapshot save for the net result of the original application and associated linked data, the conversion of the displayed data into another image format achieves the spirit of the disclosed invention in that aberrant or malicious computer viral code is inhibited, but not necessarily prevented from surviving the conversion process. A rapid series of screen image snapshots could be effected and purged in RAM and displayed as image files on the screen. Complex documents could be converted by multi-platform conversion programs such as Adobe's Acrobat® pdf or portable document file system. Such a conversion, although not essentially real time, could be employed to receive questionable data in a software staging area where file conversion could progress and the user permitted to view the resulting document file in the normal manner. However, it is recognized that the conversion program could itself be susceptible to viral attack before the transformation process began. However, if such a program were altered such that a series of document snapshots were performed and a suitable document file created representative of the original document, viral attack vulnerability could be minimized.

When discussing applications such as Acrobat, It should be noted that pdf conversion time could be significantly reduced at the expense of document resolution and provide a limited degree of viral protection. In one experiment, 2 files totaling ten pages was created in Adobe PageMaker 6.0, and the same 25 megabyte image was placed on each page. Using an Apple Macintosh Power PC 266 Mhz computer, Adobe Acrobat 5.0 was employed to convert the document into a pdf file. Conversion time took more than 11 minutes. In contrast, a similar document was produced where each page contained screen snapshot PICT files of the aforementioned 25 megabyte image. Conversion of this document required less than 22 seconds. While the resolution was reduced in contrast to the normal pdf conversion, image and text could be readily discerned and would be satisfactory for many requirements.

In still yet another embodiment of the disclosed invention, the staging CPU (SCPU) can serve as a proxy PC for the primary PC workstation. Web surfing or email interaction may be performed with impunity without fear that aberrant viral code will affect the primary CPU. Hacker attacks are limited to the SCPU area. Further, downloaded programs which are of questionable origin or integrity, may be operated and executed in proxy by the primary CPU acting via the SCPU. The input and output to the program are not compromised. In fact, one benefits from the program use while confined in the SCPU region, yet during this “quarantine” phase, various tests may be performed before the decision is ever made to transfer the actual program over the firewall. Such a system provides further benefit in that proprietary programs so operated in proxy cannot be de-compiled or reverse engineered.

Image Files and Hidden Viruses

Image files are transmitted in a variety of file formats. Some of these formats include EPS, TIFF, PICT, BMP, GIF, and JPEG. Often, such image files are compressed to save disc storage space or to speed transmission. Since it is often assumed that such files will eventually be reduced to printed media, when compression is performed, such as with JPEG files, detail data is often left out which might be lost when the hard copy is created. Similarly, GIF files are generally only intended for display on a monitor and as such are often of poor quality when printed, since only minimal data is stored.

Image file formats are transmitted in clearly defined data packets, where pixel grayscale, color, placement, checksums, and compression-expansion information is provided. However, it should be noted that additional images, viruses, and other data can be hidden or appended to such image files. The disclosed invention offers a means to detect and reinterpret an image in a digital format that can be completely unrelated in form and function to the original transmitted image being detected.

The invention can transmit such image data which may or may not result in image degradation, depending on how the information is transferred through the image staging area, the desired time interval for such transfer, and the desired output resolution. In instances requiring the highest web, surfing security, entire web pages may be observed, detected, and retransmitted as completely new digital images, albeit in some cases, with reduced resolution.

High resolution yet maximum security text data transfer, such as with email, can be accomplished by placing text through the image array staging area and subjecting the resulting detected text glyph image to OCR or Optical Character Recognition. While a not a real time process, such utilization of the disclosed invention yields the highest resolution and safety from virus attacks.

Disclosed Invention Provides Faster Data Transfer Rate

The disclosed invention will not slow data transmission in many applications if geographical coordinates are used to represent a given symbol via an optical staging area. Because solid state image arrays are easily capable of 1 megabyte resolution, each axis can contain up to 1000 pixel emitters or detectors, depending on device function. As such, each row can accommodate a remarkable number of font glyphs or control functions. For example, the binary equivalent of decimal number “219” is “11011011”. In the disclosed invention, such a number would be represented by geographical coordinates. Rather than transmit, for example, a sequence of potentially large X-Y coordinates such as decimal 65×35, which would entail transmitting a binary string of 01000001×00100001. It is preferred, that in a staging area, a series of flags represent a given line in the array. If this were applied to text data transmissions, then a single pixel flag signifying a given line would obviate the need for ½ data transmission requirement for a coordinate that corresponds to a given character. An optional initialization test may be employed to verify area array optocoupler integrity or “dead” pixels to assure proper control flag function.

Principal Components of The Invention In Summation

The essential theory for the disclosed invention may be summarized as converting digital computer information, such as but not limited to, emails, email attachments, web surfing, and any data that can be viewed on a screen, to an image and then back to code will filter out viruses but not legitimate information. This is because electronically viewing an image (picture or text) and converting it to code removes all code information that gave the image its characteristics (font, color, etc.) while still retaining the characteristics of the image. The conversion of the image back to code causes new code information to be generated which will give the image its original characteristics to be created. If any virus is part or parcel of, for example, an email attachment, this will not show up as part of the image so it will be removed in the process.

Let us first discuss the concept of this invention in review. Data (as a binary series of 1's and 0's) is input to a staging cpu “(scpu)” and sent to a video screen, i.e. the data is converted from binary to graphical form. A picture of this screen is scanned into a suitable image detector, generally consisting of many (several million) photodetectors. The data is then reconverted into a binary code. A virus may not appear on the video screen, or if it does it will be a clear aberration. If this aberration is picked up by the screen detector, then it will be as video information of the virus and not the virus itself. This data is forwarded to the cpu (representing the actual computer), where it is processed by the commands given by the human and/or software packages in extent (such as Windows). It is finally displayed on the computer's video screen (called the final screen).

In constructing this invention, there are many ways to build the necessary components. In one case, the invention can be built as described above. In another case, the video screen and detector screen can be built as one single solid-state sandwich or constructed together on a single integrated circuit die. The human operator would not be able to see a display of the data plus virus as described above, unless the operator specifically requested to see this on the final screen. The video screen proposed, can be any flat plane electronic device that outputs video (i.e. light). This includes but is not limited to all sorts of LCD displays, LED displays, laser diode displays, and phototransistor displays. The screen detector can be any flat plane electronic device that converts light input into an electrical output, with the added restriction that the light output varies with the geographical location of a point of light (pixel). This includes but is not limited to CCD devices, photodiode arrays, phototransistor arrays, or thermal arrays that convert the temperature of the light to a usable binary code, photoresistive arrays, and even magneto-sensitive and chemical-sensitive arrays that are effected by light intensity and use this light to output a usable electric signal.

Patent priority in this case even extends to the case where a signal plus virus is input to a standard computer, with the computer operating functions “locked” to reject any control data and given the single directive to output this data on to a display device, with no processing of the input data. The human operator can then check the data visually to see any possible virus. This is NOT foolproof, since a virus may be present and not show up on the screen. Nevertheless, this technique is part of the present invention and can form the basis of less reliable version of the present invention. The less reliable version would nevertheless be more reliable than many of the anti-virus techniques presently used (software packages generically called firewalls), or it can be used in conjunction with these techniques. The less reliable version would be preferred in cases where the cost and complexity of the present invention prohibit its use.

A second use of this less reliable technique is that it can be a “visual checker” of viruses. This would be similar to the use of “eye” diagrams to check the jitter in digital data. Known viruses can be “fingerprinted” by the fact that they produce a certain aberration in a normal screen picture. An unknown virus would produce a fingerprint not yet known, which would allow one to call it a new virus. Viruses that produce no fingerprints in this fashion could not be checked, but according to random statistical analysis this group should be in the minority.

Finally, the disclosed invention provides a means to operate, use, and fully interact with an application program file attachment that may contain a virus. By confining the attachment file to the SCPU, the results produced by the program may be conveyed safely across the optical area array interface. Such file execution by proxy in quarantine yields benefit of said program devoid of any means to compromise the operational integrity of the primary CPU or mainframe. Execution of such attachment be performed indefinitely while in proxy, where the user is free to define when and if said attachment is ever transferred across the optical barrier. Alternatively, the program or executable file in question may be reconstructed on the “safe” side of the optical firewall using an appropriate application program developed for such a purpose. For example, a Microsoft Word document may be executed in proxy in the SCPU and displayed page by page across the optical interface, where a conversion program identifies the text, font, position, and overall document setup, creating a new Word document in the primary CPU secure environment. Such a new document may now be fully used and altered in much the same manner as the original document which may be contaminated with a virus or other undesirable characteristic. Such file conversion therefore yields a virus free “clone” of the original document.

It is understood that some executable file attachments and programs may not so easily be “cloned” using the optical firewall. However, it is important to emphasize that in such cases, a questionable file or application may still be operated in complete safety in SCPU proxy mode using the optical firewall, during which conventional software based virus scans may be effected on potentially affected code.

It is important to bear in mind that no antivirus software or firewall yields any isolation from the internet as does the disclosed invention. Acting as a proxy PC, the SCPU concept provides a secure means of surfing the net, receiving and sending emails, and downloading and executing programs, all without fear of compromising the primary CPU, workstation, mainframe, or server.

### REFERENCE NUMERALS IN THE DRAWINGS

| | |
|---|---|
| 10 | Image Display |
| 20 | Image Detector |
| 30 | Graphical Data |
| 40 | Region Reserved for Control Functions |
| 50 | Photo Detector Array |

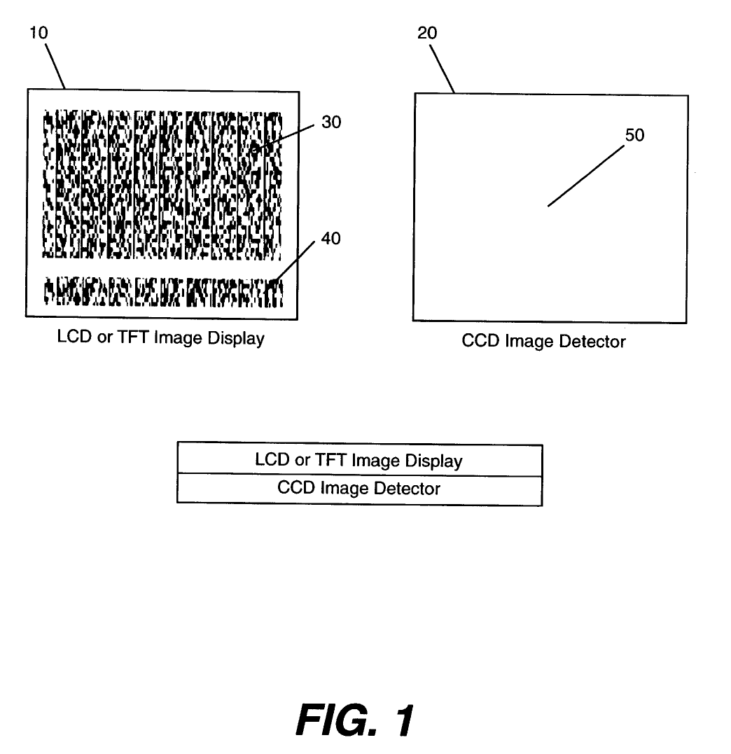

### DESCRIPTION—FIGS. 1 to 4

FIG. 1 shows an embodiment of one type of electronic display 10 of the scpu, where binary data is represented as geographical coordinates 30 to be reconverted into binary information during post processing. Specific control functions or flags in the preferred embodiment are confined in one region 40. The image displayed by the SCPU is detected by a suitable image area sensor 20. The detector resolution is determined by the number of opto-detector cells 50.

Alternatively, graphical data, comprising a picture or text or combination thereof, may be displyed on a suitable image display 30, where such displayed image or text or other data is captured by a suitable area array image detector 20. The combined area array detector 20 and area array emitter display 30 may be sandwiched together or fabricated on a single integrated circuit die.

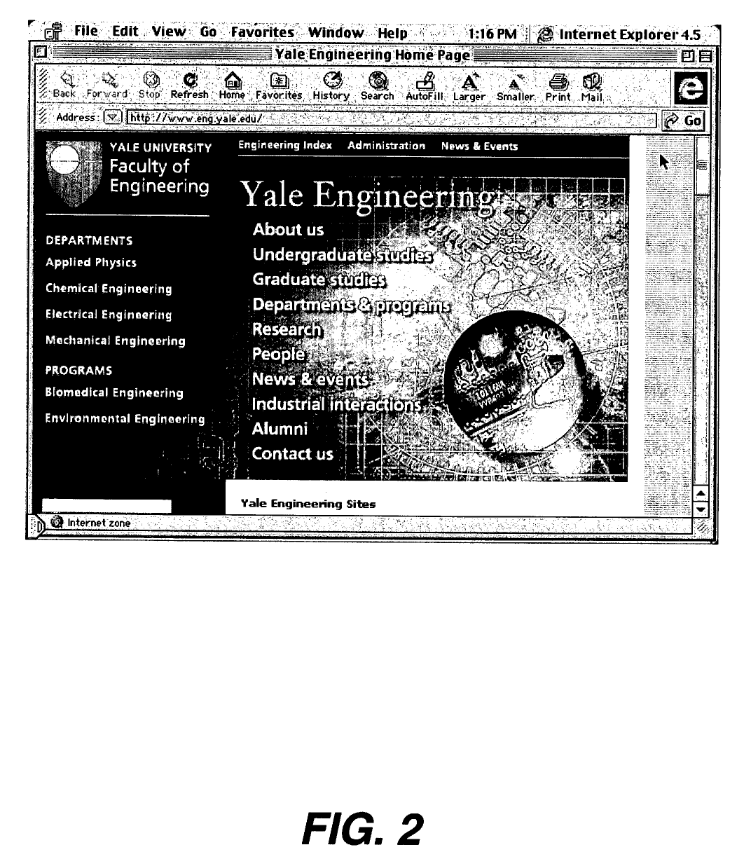

FIG. 2 illustrates a screen snapshot of a typical web-page from a CRT display that contains a virus embedded in the data code.

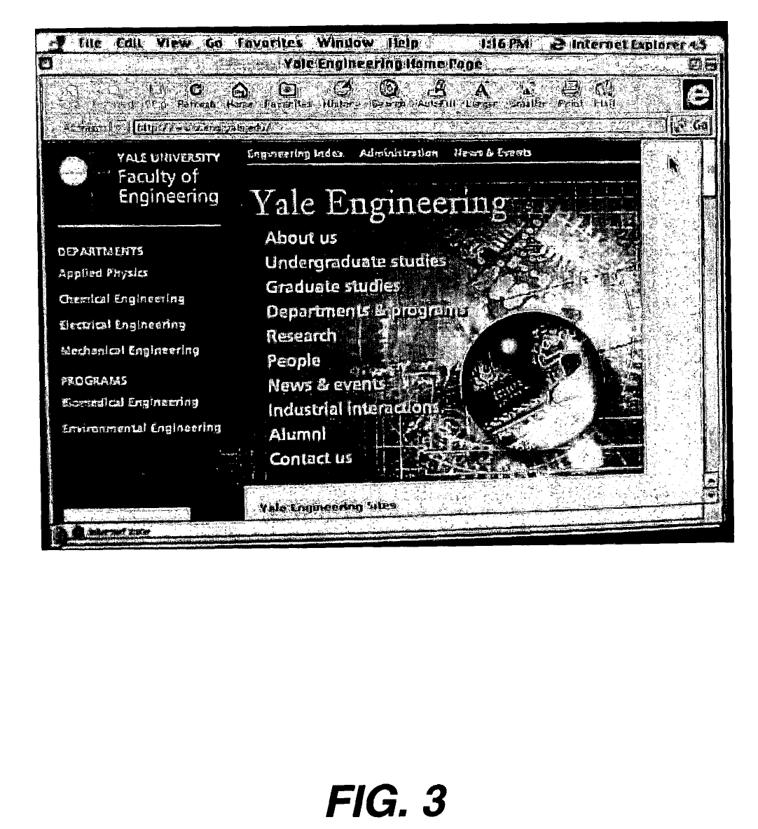

FIG. 3 is the same web-page image illustrated in FIG. 2 photographed using a Sony Mavica digital camera. The recorded image is a JPEG image file and is displayed on a second computer. The resulting image is devoid of any embedded virus code. The information provided by the image and associated text remains legible and usable. The file may be safely saved or printed.

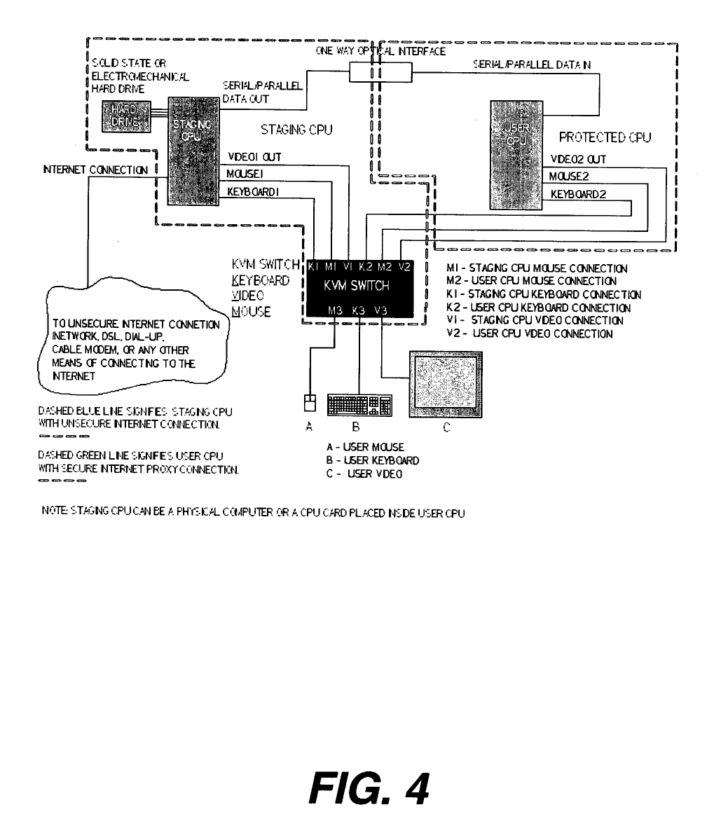

FIG. 4 is the proposed firewall acting in proxy mode. In this application, the user is interacting with the staging CPU through the normal active desktop or workstation. Mouse, keyboard, and screen data and use is actually a proxy of actual staging CPU activity. The host or primary CPU permits full interaction with web surfing, email, or program application use and execution, but is confined to the staging CPU area. Aberrant code or hacker attacks cannot pass through staging CPU to primary workstation CPU.

I claim:

1. A method for filtering a computer virus out of an e-mail or data signal, comprising:
receiving a message that has the form of digital data, providing an imaging program which can convert digital data to a viewable image, using said imaging program to converting said data to a viewable image, providing an encoding program which can convert a viewable image to visual data, using said encoding program to convert said viewable image to a representative second group of data that are representative of said image, whereby any computer virus which was a part of said received message or data will not be present in said representative second data set.

2. A system for filtering a computer virus out of an message, comprising:
means for receiving a message that has the form of a first group of digital data, an imaging program for converting said first data string to a viewable image, an encoding program for converting said viewable image to a representative second data set, whereby any computer virus which was a part of said received message will not be present in said representative second group of data.

3. A system as described in claim 1 where a program attachment may be executed and operated in quarantine, the output data of which is transferred optically across a display device and detected by a suitable area array detection device.

4. A method as in claim 3 where the displayed image or result of a program execution operated in proxy is converted into a document file that mimics the original document executed in proxy.

5. A method of antivirus protection where the result or output of a file for a given application program is converted to an image file.

6. A method where the output or result of a program or file execution is compressed by conversion to an image file.

7. A method where digital or analog data is represented by a pixel or geographical position on an area array image display.
